(19) United States
(12) Patent Application Publication
(10) Pub. No.: US 2024/0302176 A1
(43) Pub. Date: Sep. 12, 2024

(54) VEHICLE BASED TOLL AND ROAD USAGE CHARGE ACCOMODATION AND HANDLING

(71) Applicant: FORD GLOBAL TECHNOLOGIES, LLC, Dearborn, MI (US)

(72) Inventors: Krishna BANDI, Farmington Hills, MI (US); Brennan HAMILTON, Birmingham, MI (US); Joseph ZANE, Birmingham, MI (US); Sathyanarayana Chary PALAKONDA, Northville, MI (US); Ivan VUKOVIC, Birmingham, MI (US)

(21) Appl. No.: 18/181,139

(22) Filed: Mar. 9, 2023

(51) Int. Cl. G01C 21/34; G06Q 20/14

(52) U.S. Cl. CPC G01C 21/3461; G06Q 20/145; G06Q 2240/00

(57) ABSTRACT

A vehicle determines that a metered road is within a predefined proximity along a road on which the vehicle is currently traveling and determines, based on map data, the presence of a first alternative road choice, that avoids travel on the metered road, between a current location of the vehicle and the start of the metered road. The vehicle also, at least a predefined distance prior to the vehicle reaching the first alternative road choice, and responsive to the determined presence of the metered road, presents the first alternative road choice on a vehicle display.

### TECHNICAL FIELD

The illustrative embodiments generally relate to vehicle-based toll and road-usage charge accommodation and handling.

### BACKGROUND

As cities struggle with decrease road usage due to more people working from home, and a transition to electric vehicles that will deprive cities of gasoline-tax dollars, often used for infrastructure, there have been a number of proposals to incorporate road usage charging (RUC) for some or all lanes of at least certain roads.

Road usage charging can allow the municipality to transition the cost of road maintenance to those who use the road. Additionally, the municipality may elect to provide one or more designated charge roads, provided for convenience and to allow people to pay a premium in order to reach a destination more quickly.

### SUMMARY

In a first illustrative embodiment, a vehicle includes one or more processors configured to determine that a metered road is within a predefined proximity along a road on which the vehicle is currently traveling and determine, based on map data, the presence of a first alternative road choice, that avoids travel on the metered road, between a current location of the vehicle and the start of the metered road. The one or more processors are also configured to, at least a predefined distance prior to the vehicle reaching the first alternative road choice, and responsive to the determined presence of the metered road, present the first alternative road choice on a vehicle display.

In a second illustrative embodiment, a vehicle includes one or more vehicle sensors and one or more processors, configured to determine that a vehicle is entering a metered road to which a predefined occupancy discount applies. The one or more processors are also configured to utilize at least one of the vehicle sensors to determine an occupancy of the vehicle. Further, the one or more processors are configured to track travel of the vehicle along the metered road to determine an aggregate charge for usage of the metered road and adjust the metered road in accordance with the occupancy discount based on the determined occupancy of the vehicle.

In a third illustrative embodiment, a method includes receiving identification of a destination from a user of a vehicle and determining that a fastest route to a destination includes at least one metered road segment requiring payment for use. The method also includes determining a second route that is projected to incur at least one of less cost than using the fastest route or no cost, and, responsive to a time difference between the fastest route and the second route being less than a predefined threshold, automatically setting the second route as a usable route to the destination in a vehicle navigation system.

### BRIEF DESCRIPTION OF THE DRAWINGS

FIG. 1 shows an illustrative example of a vehicle and backend tracking and payments system;

FIG. 2 shows an illustrative example of a routing process;

FIG. 3 shows an illustrative example of a last-exit evaluation process;

FIGS. 4A and 4B shows an illustrative examples of vehicle displays;

FIG. 5 shows an illustrative example of active charging monitoring with vehicle confirmation collection; and

FIG. 6 shows and illustrative process for headcount collection and charge adjustment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

Historically, RUC and other charging has been a difficult concept to implement without specifically designated tolling lanes. Toll lanes and roads, however, may require dedicated infrastructure (such as toll booths), limited access points, personnel expenses, enforcement expenses, etc. Such lanes cannot be easily transitioned into non-charged lanes at time of low-traffic volumes, when the notion of payment for ease of travel is largely inapplicable, but it may make more sense to simply open all lanes to free travel. Conversely, a municipality cannot easily transition a lane into a cost-based lane during times of heavy travel, where a higher premium may be commanded for usage of a lane.

Charged lanes and tolled roads may also incentivize the building of new convenient routes, if there are reasonable assurances that such routes can recoup a portion of their cost. Such recoupment would be more easily accomplished if the municipality had a cost-effective method of tracking and charging travelers that did not involve expensive infrastructure.

Further, private landowners may be incentivized to provide road-access and even provide roads, if they had some assurances they could charge parties for using those roads. Very few landowners would be interested in installing a tolling system and/or paying operators to collect tolls for usage of a private access or trail, but if those landowners could be easily compensated based on usage without requiring any (or very limited) infrastructure, numerous alternative routes may be provided.

The illustrative embodiments provide a vehicle-centric system that includes a vehicle capable of tracking and reporting, as well as paying-for, if desired, its own toll road usage and RUC road usage. The vehicle can determine when it is in a tolled or RUC zone, track whether the vehicle continues to use such a zone, track and report and variables (such as occupancy total) that may be used as a cost-offset, and provide user assurances that the charging is accurate. Further, the system can determine the tradeoffs in time and cost between charged and free routes, recommend alternatives to charged routes, and even notify a user of a last-chance exit prior to entering a charged portion of a route.

In the latter instances, the system may be useful in continually informing a user when it is reasonable to take an alternative cheaper route, which may be a free route or a route with less total cost. For example, a user may generally know that an alternative route is seven minutes longer, but the user may not know when there is significant traffic on the alternative route. Users may also not consider the cost of the alternative route in terms of real value measurable as, for example, fuel usage. If a user knew that avoiding a two-dollar toll would use an extra gallon of fuel in order to do so, in additional to incurring a delay in travel due to a longer route with more stops, the value of the toll route would be immediately apparent. The illustrative embodiments can incorporate ancillary costs into a route consideration. This can even include the user ascribing a value to time, or limits on time usage for free alternative routes, in order to efficiently and correctly derive a best-value route for that user.

At the same time, a vehicle display can show a user present travel times, travel costs, aggregate travel costs, etc. Vehicle displays can be configured to show any tolling or charge-related information, as well as provide audio prompts for when charging is incurred or ongoing, or when a route decision needs to be made to accept or avoid charges. Users can incorporate overall preferences related to charging into route planning to have a route that most closely matches their preferences, based on real-time data.

For example, if charges changed with traffic volumes or times-of-day, it may be very difficult for a user to know the present cost of a planned journey. Moreover, the user would not know if an alternative route was a time or cost-effective alternative route.

Via a configurator, the user could elect preferences for payments (e.g., cost relative to distance or time saved) as well as aggregate time expended or ratios of time expended for taking a free or lower-cost alternative route. So, the user could specify that any alternative route that was no more than 10 minutes extra in time was suitable and/or no route that added more than 5% total travel time was suitable. This gives a user flexibility in pre-planning a route and allows the user to know that the route produced generally met specified preferences. At the same time, the vehicle could always show the fastest route and any associated charges, so that the user could always elect that as an alternative route if the user happened to need the fastest route at any given time.

Road usage charging, if done in a variable manner, can also reduce traffic by encouraging use of alternative routes by people who do not want to pay for road usage. So, for example, during certain hours of heavy traffic, charges for one or more lanes could be enabled. This may only be a practical solution if there is a way for vehicles to self-report, however, which the illustrative embodiments provide.

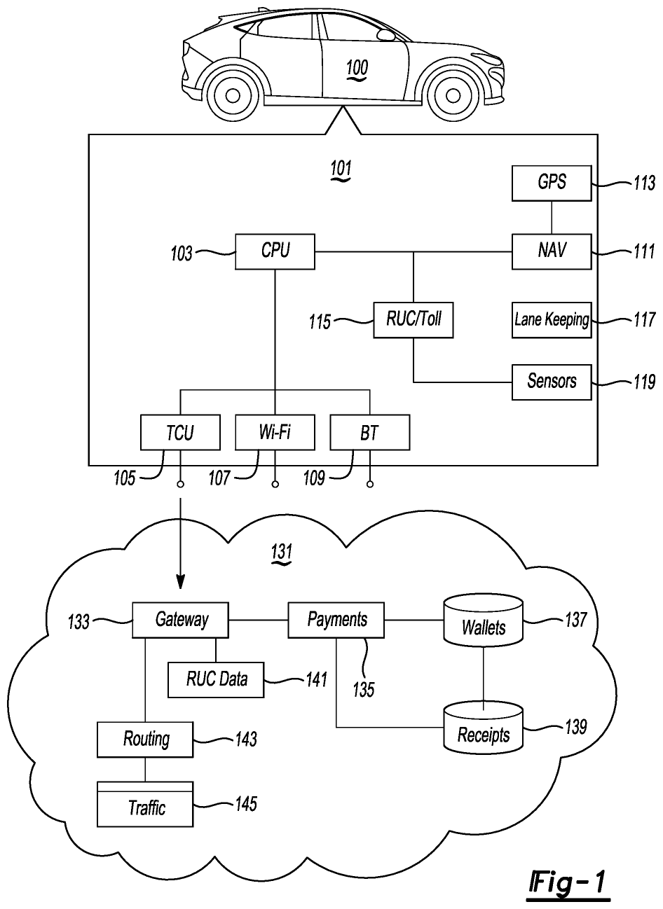

FIG. 1 shows an illustrative example of a vehicle and backend tracking and payments system. It is worth noting that many aspects of the illustrative embodiments could also be accomplished using a mobile application, although some of the vehicle-sensing confirmation aspects may be then lacking. This, however, would allow users of older or less technologically sophisticated vehicles to still participate in using such systems.

In the example shown, a vehicle 100 includes an onboard computing system 101. The system includes one or more processors 103 and a variety of communication mediums. These mediums can include, for example, a telematics control unit (TCU) 105, capable of cellular communication, a Wi-Fi transceiver 107, BLUETOOTH, BLE and ultrawideband (UWB) transceivers 109, etc. The TCU 105 may be primarily responsible for communication with a backend 131, although Wi-Fi transceivers 107 can also assist in such communication when an access point is present.

Also in this example, the vehicle 100 includes a variety of onboard navigation and sensing systems. GNSS receiver 113 allows the vehicle 100 to determine its position, which can be useful in tracking road usage. Lane-level GPS exists, but is less common at present, so additional considerations may be required if a vehicle is traveling in a metered lane that is not physically walled off from other lanes (e.g., so the user can move in and out of the metered lane at will). Nonetheless, lane-keeping sensing 117 working in conjunction with vehicle cameras 119 and other sensors can allow a charge calculation process 115 to track lane usage with reasonable accuracy.

Further, as discussed later herein, the vehicle can snapshot (with data and actual images) believed points of entry and exit, as well as periodic points throughout a journey, so a user can confirm the validity of a toll charge. An icon on a display may allow a user to see when charges are accruing, so if the user sees the icon but is not traveling in a metered lane, they can also immediately take a snapshot and potentially even automatically submit the snapshot for human or artificial intelligence (AI) review to dispute the charge. Based on distance from medians, presence of other vehicles, GPS and other factors, a machine-learning AI process could become reasonably adept at reviewing images to confirm or reject the validity of a charge. Such processes could also execute onboard the vehicle an analyze images periodically taken during a metered journey to confirm that continued metering was still appropriate. These processes could also be disabled while the vehicle is traveling on a physically separated and designated road, to save on compute overhead and free up vehicle computing resources.

A vehicle navigation system 111 can store a record of a route, including toll points and known last-exit points. This allows the navigation system to alert a user well in advance of a metering point and/or exit point, so decisions about which lane or route to take can be made with relative care. The navigation system may also accommodate a route plan that involves certain lanes (such as selection of a for-charge lane) and may incorporate lane-changing instructions into its navigation directives as the user approaches a planned usage of a metered road. Metered roads refer to both tolled and RUC roads, as well as any other road that has a usage-cost associated therewith.

The backend 131 may include a gateway process 133 for request and response handling and may be responsible for a variety of vehicle services. In this example, those services can include storage of user wallets 137 and charge receipts 139. That allows a user to freely and quickly pay for tolling and RUC charges, as well as recover and view any past charges incurred.

A payments process 135 can facilitate payment from a variety of user-selected mediums, which can be chosen using an onboard application or an application provided with toll and RUC payment handling capability.

To the extent that variable tolling and RUC charges exist, the process may also include up-to-date RUC cost information 141. This can include updates about live cost changes, if a municipality or private landowner adopts a variable charge strategy based on time of day, aggregate usage, etc. Municipalities may not use such variable systems as frequently, but it is quite possible private landowners providing alternative routes may want a variable-cost system in place based on demand and usage.

A routing process 143 may provide routing services, route comparison services, route evaluation services, etc. The backend 131 may have up-to-date information relating to traffic 145 as well as other ancillary cost concerns, such as fuel cost data and other factors that may affect the aggregate cost of an alternative or chosen route. Much of this data can be provided to a mobile device or vehicle that performs comparable services as well.

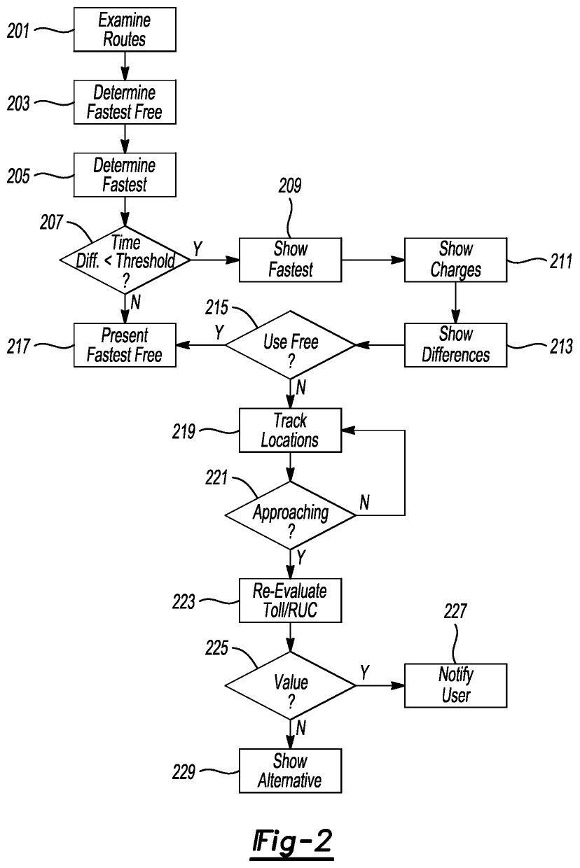

FIG. 2 shows an illustrative example of the routing process 143. In this example, the vehicle or routing process will contemplate a planned or commonly-used route, to evaluate possible alternatives as well as costs associated with each route. Costs can be measured in a variety of factors, including wear-and-tear, time and fuel. A metric for vehicle degradation can be assigned for wear-and-tear value and may be generalized per mile traveled. Users can ascribe their own values for time, if they want to translate the cost of time into a fixed unit. Fuel usage can be contemplated based on current average fuel costs for a locality. The system could even contemplate, for example, an average available number of miles per month remaining on a lease, and ascribe an additional cost per mile if the user was trending towards milage overage on a lease, which can often be expensive.

The process can first determine the fastest “free” route at 203. This is a route that does not utilize any metered roads, if such a route is possible. The determination of the route can simply contemplate total duration, or it can include a more comprehensive cost analysis if desired, which can incorporate the preceding cost-factors and the like. The process can also determine the fastest metered route at 205. Depending on a length of the route contemplated, one or more tertiary routes may also be considered, such as routes that use less metering than the fastest metered route, but which may be similar in travel time and lesser in overall cost. If a more complex cost-based analysis was used, these routes could include a most cost-effective route (i.e., the cheapest route when all cost variables were accounted for).

In this example, the process also considers if a time difference between the less-cost (free or cheaper) route and a fastest or faster route is below a threshold at 207. The threshold could be a fixed time value or a percentage based comparison that is relative to total travel time. The comparative is not necessary, but may be useful in that it may demonstrate a minimal time savings for significant cost (relative to time saved). A user may also be able to set the threshold, so that, for example, setting the threshold to 0 would only provide the cheapest route if it were actually the fastest. Setting the threshold to, for example, 5 minutes, would only provide the cheapest route if it were substantially comparable in time to the fastest route.

If the time difference between the routes is not above the threshold at 207, then the cheapest route is provided at 217, as the fastest route is either the same route (threshold 0) or does not provide significant time savings for the tradeoff in cost. If the fastest route is more than a threshold faster than the cheapest route at 207, then the process shows the fastest route at 209 as the recommended route. In this example, the process may also show the charges associated with the route at 211 and show the differences between any alternative routes at 213.

For example, the fastest route may take 40 minutes of travel and cost $3. The process would show this information, along with possibly showing an alternative 55 minute free route. If calculated, the process could also show estimated fuel usage on both routes, as well as estimated wear and tear or mileage cost associated with each route. In some instances, the fastest route may be a longer route, but at a much higher rate of speed, and in that instance the fastest route may have its cost increased by the additional mileage incurred for traveling thereon, again, if mileage is taken into cost-consideration.

The user may elect to use the free or cheaper route at 215, in which case the cheaper or free route is presented at 217. Otherwise, the process may engage tracking of user locations as the user travels at 219. While tracking is not a necessary step, this allows the process to provide adaptive feedback that may change a user decision process. For example, traffic could develop on the fastest route or diminish on the cheapest route while the user is traveling. That may change the user's decision to use one route over the other.

Once the user approaches the metered portion of the route (or any other point where branching to a different route would be reasonable) at 221, the process re-evaluates the reasonableness of the metered route at 223 in terms of cost for value. If the value proposition remains at 225, or has not changed beyond a threshold at least, the process may notify the user at 227 that a last-exit for a cheaper route is still possible, but that the current route is still the preferred route. Otherwise, the process may show an alternative route with an altered value proposition at 229.

The cheapest route and fastest route may share one or more common or proximate roads, for at least some portion of a journey. Thus, the re-evaluation process could occur at a point of divergence (past which it becomes slow or impractical to switch to the other route), as well as prior to a last-exit prior to a metered portion of a route, if that is different from the point of route-divergence. The alternative route in the last-exit scenario may not be the same route as the prior cheapest route, so the process would re-evaluate the alternative route in light of any new maneuvering required if the user elected to avoid toll costs at the last minute.

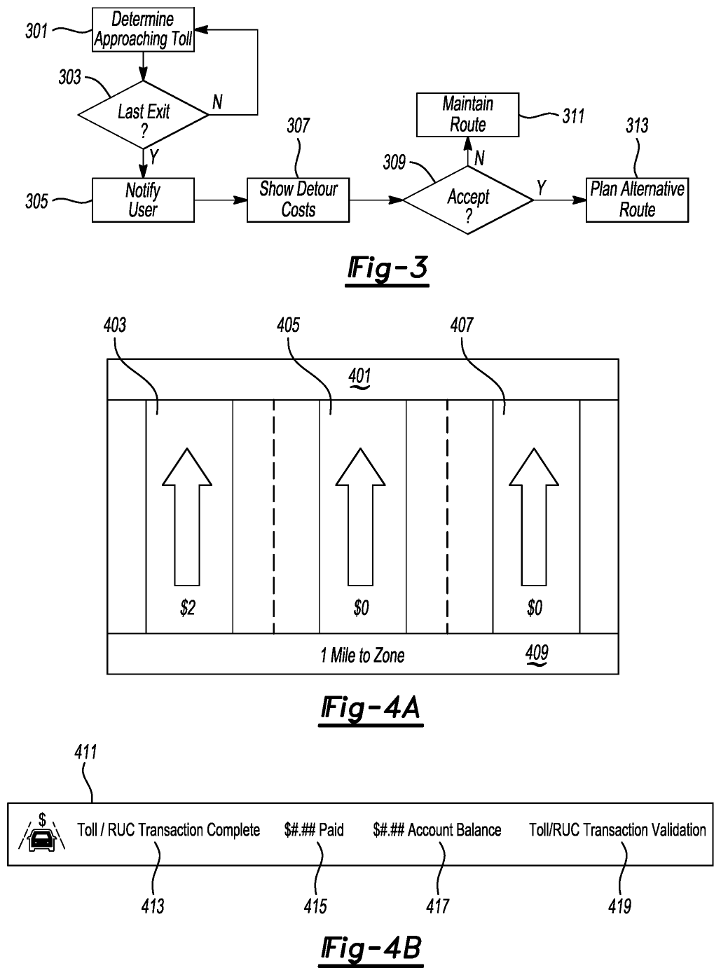

FIG. 3 shows an illustrative example of a last-exit evaluation process. This is a process similar to that previously described, but one that can be run any time an upcoming route includes a choice between a metered and unmetered road. The system may also provide this alert even in the absence of a known route, although in that instance the user may require some local knowledge as to whether any alternative route would suitably lead to a destination. Nonetheless, to the extent that municipalities start including RUC for common roads with which local users may be familiar, it would be useful to know at least one opportunity to avoid a charge prior to the charge beginning to accrue. In many instances, local users will know plenty of alternative routes between local points, and so being informed of a last-opportunity to avoid a charge will allow those users to use local road knowledge and not pay charges. If a destination is known by the vehicle 100, such notifications can include projected travel time on the metered and unmetered routes as well as cost differences.

Whenever the process determines that a metered road segment is upcoming at 301, on a current road, for example, the process may also determine if any turn-offs, exits or other alternative options represent the last exit at 303. In a case where a destination is known, the “last exit” may not actually be the last exit prior to the metering, but may be the last exit that actually allows the destination to be reached by circumventing the metering or the last exit that does not add more than a threshold amount of cost or travel time. If there is no known destination, the last exit notification may occur at the literal last exit or at a last exit that does not lead to, for example, a dead-end road system or other relatively useless alternative, such as a parking lot, unless the alternative permits the user to reverse course if desired.

The process will notify the user of the existence of the last exit at 305 and, to the extent the destination is known, provide an estimate of alternative routing costs at 307. This can include time durations, travel distances and accrued costs in fuel, time, wear and tear, etc. The user can also accept an alternative route at 309 and be provided with an updated route circumventing the metering at 313, or maintain the current route at 311.

Even if a route is not currently planned, a user may accept a route-around option to provide a turn-notification. For example, two miles in advance of a last-exit, the system may tell the user “Smith Street will be the last chance to avoid metered travel.” The user, who has no stored route in this example, may elect to accept a notification so that, in two miles, the user is alerted to the presence of Smith Street, even though additional routing will not be provided.

FIG. 4A shows an illustrative example of a vehicle display with lane costs. This is an illustrative display 401 of a three lane road that could be displayed on an in-vehicle display or a mobile device display. If there was not an available in-vehicle display, in addition to displaying the information on a mobile device, the vehicle may audibly speak the information related to the lane choices.

In this example, the left-most lane is a metered lane that costs $2 to use for some distance. This is more akin to a toll-scenario, and the cost may be for a segment of the road and/or for an amount of time or distance corresponding to a user's need for the road as indicated by a preplanned route. Thus, $2 could also represent an RUC that is relevant for that particular user. If the road was an RUC road and there was no route, the process might show the cost for using the road in terms of distance traveled (e.g. $0.40/mile). Other lanes 405 and 407 are free lanes, and the system could further enhance the experience by showing, for example, a traffic status of each lane until a transition could be made.

That is, if a user can opt to use the leftmost lane three miles down the road, then the traffic status may indicate the traffic state of each lane for the next three miles. A simple color coding could be used, for example, with variants from green to red based on traffic volume and travel speed impact. The same data would be useful to indicate whether the user should stop using the metered lane if travel on the free lanes was unimpeded after some portion of travel on the metered lane. This also assumes that the user cannot move at will between the various lanes. The display may also show a distance 409 until the metering begins, so that the user has time to make a decision.

FIG. 4B shows an illustrative example of a vehicle display 411 that can show when a charge action is complete. For example, as a user transitions from a charged lane to a free lane, or from one charged lane system to an alternative charged lane system and a charge is incurred.

The icon 413 is informational to inform the driver that a tolling charge has been completed. This may also be accompanied by some explanatory text that notifies the driver of the nature of the event. The display 411 may also show an amount paid 415, as well as an account balance 417, if the driver is using an account with a balance (as opposed to, for example, a debit or credit card, if those are alternative options). Finally, the display may provide an option for verification 419.

Each displayed option may be selectable and may provide more detail upon selection. For example, selection of the amount charged could show a breakdown of cost per mile and miles traveled, along with any discounts. Selection of a an account balance could show some number of recent transactions completed. This may be an expandable or contractable list, and may be sortable by time, day, etc. Another option would be to initially show all charges incurred on a present journey—e.g., since the user left the house, since the vehicle was last parked, etc.

The verification option can show, for example, GPS stamps when charging was initiated, as well as any supporting data such as camera footage or gantry-communication. The display may also show a stretch of road (such as a portion of a route) for which charging was incurred. A variety of options may be available here for a user to confirm the appropriateness of charging. There may also be a selectable option to dispute a charge, which can, for example, open a communication channel, or send an automatic dispute notification to a server. The user may be required to provide additional details at a time when the vehicle is not being driven. The details may be provided through the vehicle or through a device (e.g., phone, pc, tablet, etc.) interface.

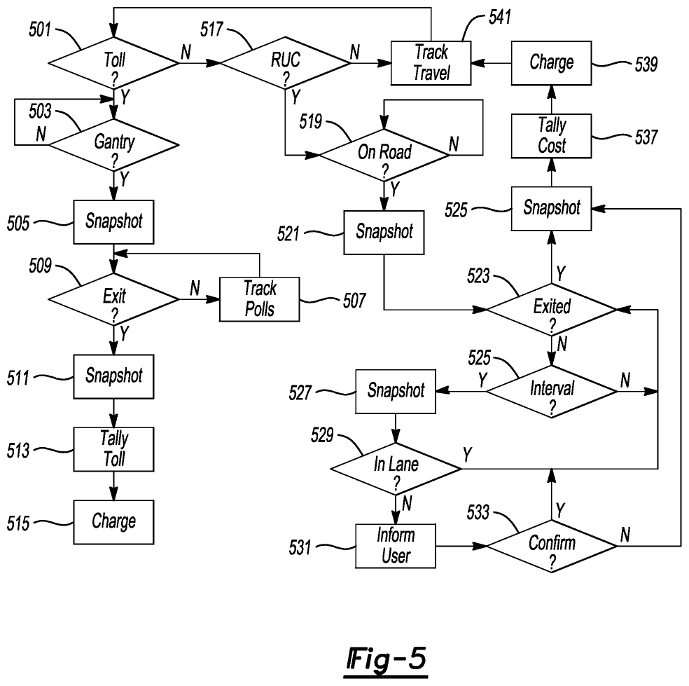

FIG. 5 shows an illustrative example of active charging monitoring with vehicle confirmation collection. This is an example where the vehicle can self-monitor toll or RUC road usage, provide evidence of usage or non-usage, and provide a user with some assurances that the charges are correct, or evidence for challenging charges if they are incorrect. If a vehicle is going to automatically track and charge metered road usage, it is potentially useful, although not necessary, for the user to have some level of confirmation about the correlation of the vehicle to a metered lane or road. This also allows the vehicle to accurately begin and end charging at appropriate locations.

The vehicle will track its own progress at 541 until a toll road at 501 or an RUC road or lane at 517 is encountered or determined to be within a certain proximity ahead on a route. Once the vehicle is proximate to a toll road at 501, for example, the process may determine if a gantry or other entry-marker is detected at 503. Currently, virtually all toll roads include gantries, however, in the future, the markers may include signs or other lower-cost structures. Markers could also include paint on the road surface and/or buried radio-frequency identification (RFID) or other wireless devices designating an entry point. Markers could also be placed some distance ahead of a gantry if desired, so that vehicles could negotiate usage of a pass-through entry lane prior to reaching the entry lane.

For example, if a marker were 1 mile away, the vehicle could detect the marker (visual or wireless marker) and offer the user a chance to use a pass-through lane. By the time the user reaches the lane, the vehicle could have negotiated credentialing with a toll system so that the user is not flagged when passing through the actual gantry. This negotiation could also occur after the user passed the gantry, based on the vehicle beginning a tolling charge having sensed and recorded the existence of the gantry, but present toll systems may photograph or flag uncredentialed users passing through the pass-through gantries (ungated gantries) and the pre-negotiation and credentialing could avoid any accidental belief that the user was attempt to travel without paying a toll. In other instances, the user could have pre-agreed to pay all tolls accrued using the vehicle, and then the vehicle may have a perpetual credential available to provide as evidence of no nefarious intent.

In this example, the vehicle takes a sensor snapshot at 505 as the vehicle passes through the gantry, indicating the start of the tolling period as well as providing evidence that the vehicle passed the tolling point. Until the vehicle elects to exit at 509, the process tracks tolls as they are accrued at 507.

Once the vehicle exits the road through another gantry at 509, the process again snapshots the exit at 511. This provides the user with evidence that they exited the road at that point, in case tolling charges were to continue to accrue. The vehicle (or backend 131) tallies the tolls accrued during travel at 513 and utilizes a stored user payment system to pay the charge at 515. The accrued tolls may also be shown to the user, along with a wallet balance if applicable, while the vehicle travels.

If the user is using an RUC lane or road at 517, the process may be slightly different. Many such roads or lanes may lack a formal gantry, and so the vehicle would image and take a sensor snapshot at 521 (GPS, lidar, wireless signal snapshot, etc.) when the vehicle believed tolling should begin at 519, which would likely be based on GPS coordinates and/or passing a wireless transceiver indicating RUC charge application, or any other suitable method of determining when the charging should begin.

While the vehicle is on the road or in the lane, the process may determine if the parameters for exit and charging are met at 523. This can include changing lanes as indicated by lane-keeping or GPS, exiting a formal exit from a separated lane, transitioning from a private to public road, etc.

In this example, because the demarcation between RUC lanes and non-charged lanes may not always be clear, or because GPS coordinates could incorrectly indicate travel in an RUC lane when the vehicle was in an adjacent lane, even if a physical barrier separated the two, the vehicle also periodically takes images and/or other sensor snapshots at 527 at intervals at 525.

The vehicle or a backend process may be able to determine, through use of machine-learning and AI, whether a snapshot indicates a presence or non-presence in an RUC lane. This can be determined, for example, based on relative lane positioning (whether there are adjacent lanes to either side), the presence of another vehicle where there should be none, the viewing perspective of a physical divider (whether it is on the left or right side of a vehicle), etc.

If the data seems to indicate that the user is not in the RUC lane at 529, the process may inform the user at 531 that they are being charged for RUC usage but do not appear to be in the RUC lane. The user can confirm whether RUC usage charges should apply at 533.

While users may cheat and indicate non-usage when usage should apply, the same imagery can be sent to the backend 131 or a confirmation service for verification, and a user can face a fine if they improperly indicate usage. Since there is documented evidence of usage or non-usage, users should be incentivized to provide accurate information, but at the same time can avoid charging for non-use instances of travel.

When the travel on an RUC segment is completed and the user is on a non-metered road, the process can snapshot exit data at 535. The process can tally costs at 537 and charge the user at 539. This may also include showing the user the estimated cost and confirming the charge. Again, if the user disputes a charge, evidence of the snapshotted data and any images can be sent as part of a challenge to the charge. Tracking travel at 541 can then resume.

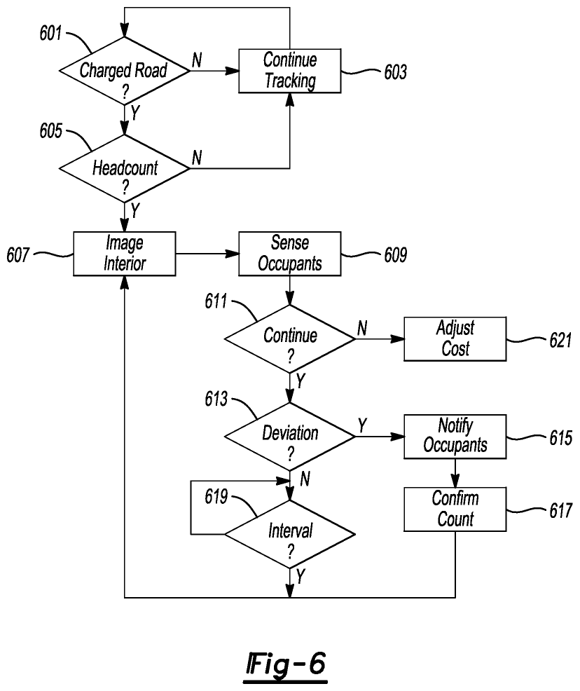

FIG. 6 shows and illustrative process for headcount collection and charge adjustment. In the interest of incentivizing group travel, certain RUC charges and/or toll charges may be mitigated or vacated based on vehicle headcount. This encourages users to travel with multiple occupants in an effort to reduce overall emission and lower congestion, for example. Again, since it can be a costly process to enforce and monitor individual vehicle headcount, the vehicle 100 can provide automatic headcounts as part of metering tracking.

In this example, the process determines at 601 if the user is on a metered road and/or at 603 if headcount has an effect on cost. If the answer to either decision is no, the process can resume normal tracking and/or charging for a metered road.

If a headcount can change a charge, the vehicle 100 can image an interior and use other vehicle sensing at 607 to determine an headcount within a vehicle. The images may not be saved unless there is a dispute about headcount, so that users do not feel like their vehicle violates their privacy. On the other hand, if a user disputes headcount or inaccurately confirms headcount, the images may serve as evidence of actual parties present.

While vehicles may be reasonably adept at sensing occupants via interior sensors at 609, such as seat-occupancy sensors, weight sensors, belt sensors, imaging, etc., the process may also occasionally incorrectly count the occupancy. In this example, the process periodically rechecks headcount to confirm a prior conclusion. Occupants may also be presented with current headcount estimates and be asked to confirm the validity of the count. If the occupant choses anything other than the confirmed number, the process may require submission of an image in order to validate a claim of a higher headcount, although a choice of a lower headcount (if the vehicle overcounted) may not require image submission.

As long as the travel in the metered lane continues at 611, the process may periodically re-image and recount the vehicle interior at intervals 619. Once multiple data sets are established, in a deviation appears at 613, the process may ask a user at 615 to validate the count number at 617. The user can confirm the total occupants or adjust the number. This is also an incentive not to lie initially if the vehicle overcounts, for example, because a later count may conclude a different (and accurate) number, and then the user could be subjected to a fine. In an effort to avoid this, the user could be given until the time of charging to accurately confirm the headcount. A vehicle could even inform the user that two different totals were detected, and if the lower total were not confirmed, then imagery of the interior would be submitted as evidence that the higher total was present. This would provide a last-chance for a user to accurately confirm information. Once headcount is confirmed, any adjustment to charging is made at 621.

Through the use of the illustrative embodiments and the like, vehicles can improve the ability of infrastructure to effectuate tolling and RUC through assurances that tolling and RUC are accurately calculated and evidence of travel is present. This also essentially creates an opportunity for landowners to open private roads for travel without requiring installation of any (or very limited) infrastructure. Having an impartial entity like the vehicle provide evidence of situations through sensor snapshots provides both parties to a transaction some assurances that charging information is accurate and defensible.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
one or more processors configured to:
determine that a metered road is within a predefined proximity along a road on which the vehicle is currently traveling;
determine, based on map data, the presence of a first alternative road choice, that avoids travel on the metered road, between a current location of the vehicle and the start of the metered road; and
at least a predefined distance prior to the vehicle reaching the first alternative road choice, and responsive to the determined presence of the metered road, present the first alternative road choice on a vehicle display.

2. The vehicle of claim 1, wherein the alternative road choice is also presented responsive to determining that no second alternative road choice exists between the first alternative road choice and the start of the metered road.

3. The vehicle of claim 1, wherein the determination of the presence of the first alternative road choice includes determining that a current route can be completed utilizing the first alternative road and wherein the presentation of the first alternative road choice is further responsive to the current route being completable utilizing the first alternative road.

4. The vehicle of claim 3, wherein the one or more processors are further configured to present the first alternative road choice via a vehicle display and, responsive to user confirmation input via the display, change the current route to deviate along the first alternative road choice.

5. The vehicle of claim 4, wherein the one or more processors are further configured to present a travel time difference between an alternate route using the first alternative road choice and the current route, prior to changing the current route.

6. The vehicle of claim 4, wherein the one or more processors are further configured to present a cost difference between an alternate route using the first alternative road choice and the current route, prior to changing the current route.

7. The vehicle of claim 6, wherein the cost difference accounts for at least one of a predefined value of user time applied to a projected travel time for the alternate route and the current route, a cost of fuel consumed using the alternate route and the current route, or a predefined value of mileage applied to a distance associated with the alternate route and the current route.

8. A vehicle comprising:
one or more vehicle sensors; and
one or more processors, configured to:
determine that a vehicle is entering a metered road to which a predefined occupancy discount applies;
utilize at least one of the vehicle sensors to determine an occupancy of the vehicle;
track travel of the vehicle along the metered road to determine an aggregate charge for usage of the metered road; and
adjust the aggregate charge in accordance with the occupancy discount based on the determined occupancy of the vehicle.

9. The vehicle of claim 8, wherein the one or more processors are further configured to:
utilize the at least one of the vehicle sensors to recalculate the occupancy of the vehicle at one or more predefined or random intervals while the vehicle travels along the metered road; and
responsive to the recalculated occupancy deviating from a prior calculated occupancy during the same instance of travel along the metered road, present a query via a display of the vehicle asking for confirmation of occupancy.

10. The vehicle of claim 9, wherein the one or more processors are further configured to send data, gathered via the at least one vehicle sensor, to an entity responsible for charging a user for use of the metered road, responsive to a response to the query indicating that occupancy is greater than a lowest occupancy represented by either the prior calculated occupancy or the recalculated occupancy.

11. The vehicle of claim 8, wherein the at least one sensor includes a vehicle camera or a seat-occupancy sensor.

12. The vehicle of claim 8, wherein the one or more processors are further configured to:
responsive to the determination that the vehicle is entering the metered road or responsive to a determination that the vehicle is exiting the metered road, utilize at least one of the one or more vehicle sensors to capture data indicative of environmental surroundings during entry of the metered road; and
provide a selectable option on a display of the vehicle, selection of which presents a view of the captured data for user viewing on the vehicle display.

13. The vehicle of claim 12, wherein the at least one of the one or more vehicle sensors includes at least one of a camera capturing visual data as the captured data, a GPS receiver capturing GPS data as the captured data, or a wireless transceiver capturing communication data, from an infrastructure element, as the captured data; and
wherein the selectable option is at least presented in conjunction with a toll charge indication, indicating reconciliation of the aggregate charge for usage of the metered road.

14. A method comprising:
receiving identification of a destination from a user of a vehicle;
determining that a fastest route to a destination includes at least one metered road segment requiring payment for use;
determining a second route that is projected to incur at least one of less usage cost than using the fastest route or no usage cost; and
responsive to a time difference between the fastest route and the second route being less than a predefined threshold, automatically setting the second route as a usable route to the destination in a vehicle navigation system.

15. The method of claim 14, wherein the predefined threshold is defined by the user or relative to a total projected travel time.

16. The method of claim 14, further comprising, calculating a first projected usage cost associated with the at least one metered road segment and a second projected usage cost associated with using the second route for portions of the second route that avoid the at least one metered road segment and that are not common with the fastest route, wherein
the second projected usage cost associated with the second route accommodates at least one of any additional fuel usage for taking the second route or additional vehicle wear-and-tear for taking the second route, and wherein
the automatically setting is further responsive to the second projected usage cost being less than the first projected usage cost.

17. The method of claim 16, further including:
responsive to the second projected usage cost being more than the first projected usage cost, presenting both the fastest route and second route for user selection via a vehicle display; and
setting a selected one of the fastest and second routes as the usable route to the destination.

18. The method of claim 14, further including:
responsive to the time difference between the fastest route and the second route being above the predefined threshold, presenting both the fastest route and second route for user selection via a vehicle display; and
setting a selected one of the fastest and second routes as the usable route to the destination.

19. The method of claim 14, further comprising:
determining that a first segment of the at least one of the metered road segments includes at least one metered lane and at least one free lane; and
responsive to the vehicle being within a predefined distance of the first segment, presenting, on the vehicle display, a visual indicator showing at least one of:
a projected cost associated with the metered lane or
a travel-time difference associated with travel over the first segment using the metered lane compared to travel over the first segment using the at least one free lanes.

20. The method of claim 19, wherein the predefined distance is determined at least in part based on a projected amount of distance required to change lane usage between the at least one metered lane and the at least one free lane.
